(19) United States
(12) Patent Application Publication
(10) Pub. No.: US 2007/0214292 A1
(43) Pub. Date: Sep. 13, 2007

(54) System and method for archiving of continuous capture buffers

(76) Inventors: Gillian Hayes, Decatur, GA (US); Khai N. Truong, Atlanta, GA (US); Lamar Gardere, Atlanta, GA (US); Gregory D. Abowd, Atlanta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/361,632

(22) Filed: Feb. 24, 2006

(51) Int. Cl. G06F 5/00

(52) U.S. Cl. 710/52

(57) ABSTRACT

Systems and methods for archiving a stream of sensor data, are disclosed. One method comprises: receiving a stream of sensor data from at least one corresponding sensor device; storing the sensor data to a corresponding capture buffer; receiving, from a trigger device, a request to archive a portion of the capture buffer; and responsive to the archive request, copying the requested portion of the capture buffer to an archive buffer. The sensor device has a coverage area, and the trigger device is located proximate to the sensor coverage area. A user explicitly originates the archive request through the trigger device.

### CROSS REFERENCE TO RELATED APPLICATIONS

Not applicable.

### FIELD OF THE INVENTION

The present invention relates to ubiquitous computing, and more specifically, to a system and method for archiving of continuous capture buffers.

### BACKGROUND

The term ubiquitous computing refers to the integration of computing devices or platforms into the environment, rather than having computers which are distinct objects. One example of ubiquitous computing is the use of capture devices such as cameras and microphones that are embedded throughout a relatively large physical environment, such as a home, school or office

Traditionally, software developed to collect information from these capture devices treats the devices as being in one of two states of operation: on or off, where the software records all data captured when the device is on. With conventional continuous recording, either too much information is recorded, or not enough. A small record buffer is unlikely to record infrequent events, although the buffer can be quickly reviewed to find interesting events. On the other hand, a large record buffer increases probability that interesting events will be captured, but also requires an observer to spend a large amount of time reviewing the entire record buffer to find interesting events.

An improvement is a large buffer system in which an observer notes, immediately after the event occurs, the approximate time that the event occurs. This does reduce the time involved in reviewing the large buffer, but because the continuous buffer is finite and so eventually discards old information, a large buffer is still required to insure that infrequent events are captured. Therefore, improvements to continuous capture buffers are desirable.

### SUMMARY

Systems and methods for archiving a stream of sensor data, are disclosed. One method comprises: receiving a stream of sensor data from at least one corresponding sensor device; storing the sensor data to a corresponding capture buffer; receiving, from a trigger device, a request to archive a portion of the capture buffer; and responsive to the archive request, copying the requested portion of the capture buffer to an archive buffer. The sensor device has a coverage area, and the trigger device is located proximate to the sensor coverage area. A user explicitly originates the archive request through the trigger device.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention.

FIG. 1 is a block diagram of an archivable continuous capture buffer 100.

FIG. 2 is an object diagram of the experience buffer 100 of FIG. 1.

FIG. 3 is a block diagram of one embodiment of a system 300 that includes the experience buffer 100 of FIG. 1, showing the system components and interactions between them.

FIG. 4 shows another system 400 that includes multiple experience buffers 100.

FIG. 5 is a block diagram of one embodiment that is particularly suited for capturing and archiving instances of human behavior in a classroom setting, and especially for capturing the behavior of children with autism.

FIG. 6 is a block diagram of another embodiment particularly suited for capturing the behavior of children with autism.

FIGS. 7A-D show an example of a user interface implemented on the client of FIG. 6 which allows viewing and editing of the object 640 of FIG. 6.

FIG. 8 is a system diagram of another embodiment particularly suited for tracking child development in a home.

FIG. 9 is a system diagram of another embodiment of a triggered, archivable experience buffer.

FIG. 10 is a hardware block diagram of an example device that implements the experience buffer 100 of FIG. 1.

### DETAILED DESCRIPTION

The systems and/or methods of the system and method for archiving of continuous capture buffers can be implemented in software, hardware, or a combination thereof. In some embodiments, the system and/or method is implemented in software that is stored in a memory and that is executed by a suitable microprocessor (uP) situated in a network device. However, system and/or method, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

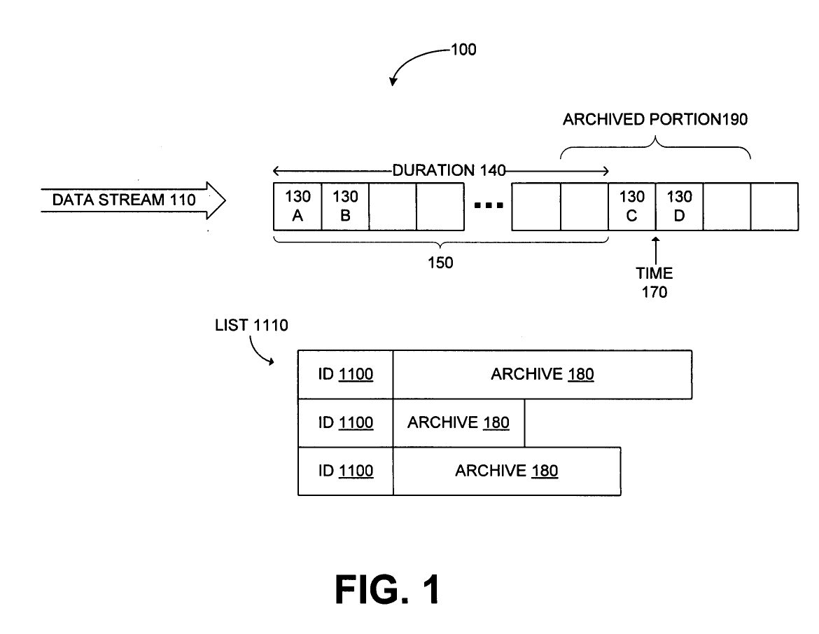

FIG. 1 is a block diagram of an archivable continuous capture buffer 100 (hereinafter called an “experience buffer”). An incoming continuous data stream 110, composed of individual samples, is recorded to temporary buffer 120. In this example, the sample interval is 0.1 seconds, so the first sample is recorded at initial position t=0.0 (130A), the next sample is recorded at the next position t=0.1 (130B), and so on.

The experience buffer 100 is configured with a duration 140, and continuously discards those recorded samples that are older than the duration 140. In the example of FIG. 1, the duration 140 is 1 minute, and the first 1 minute of recording is stored in logical block 150. At time t=1.0, the sample 130A from t=0.1 is discarded. At time t=1.1, the sample 130B from t=0.2 is discarded. Note that the recording of incoming data stream 110 continues also, with new samples t=1.0 and 1.1 recorded at logical positions 130C and 130D.

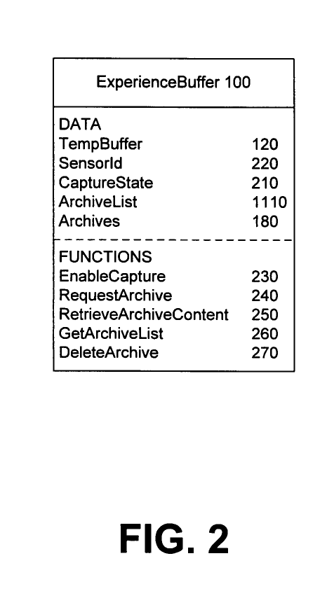

Although data older than the duration 140 is continuously discarded, the experience buffer 100 allows a portion of the temporary buffer 120 to be archived, or saved to another location, before discard. Importantly, the requested portion is identified as an interval 160, and the interval 160 is interpreted as relative to the current time 170. In response to an archive request for a given interval 160, the requested portion is identified and copied to an archive 180. The archive storage 180 is distinct from the continuously recording temporary buffer 120. In FIG. 2, for example, an archive request having an interval of 0.4 seconds occurs at current time 170=2.7. The requested portion is determined to be t=2.5-2.7 (190).

The experience buffer 100 also stores information 1100 which identifies each archive 180. Identifying information 1100 may include the archive time span (preferably in absolute rather than relative form, e.g., 11/15/05 18:04:15-18:12:45) and the source of the data stream 110. Additional information associated with the archive 180 may also be stored by the experience buffer 100. Multiple archive requests during the continuous recording (each for a different portion) result in multiple archives 180, so the experience buffer 100 maintains a list 1110 of archives 180.

As depicted in FIG. 1, the currently recording portion can be understood as a window which advances through the temporary buffer 120, where the temporary buffer 120 has a size larger than the duration 140. Samples earlier than the window have been discarded, and new samples will be recorded ahead of the current window position. Seen from another point of view, the temporary buffer 120 is of size equal to the duration 140, and the temporary buffer 120 is a circular buffer. That is, instead of advancing forward, the current record position wraps from the end of the temporary buffer 120 back to the start, and new data writes into the same position that contains old data. Note, however, that the circular buffer is merely a logical abstraction, and new data does not necessarily overwrite the old data at the same physical memory location.

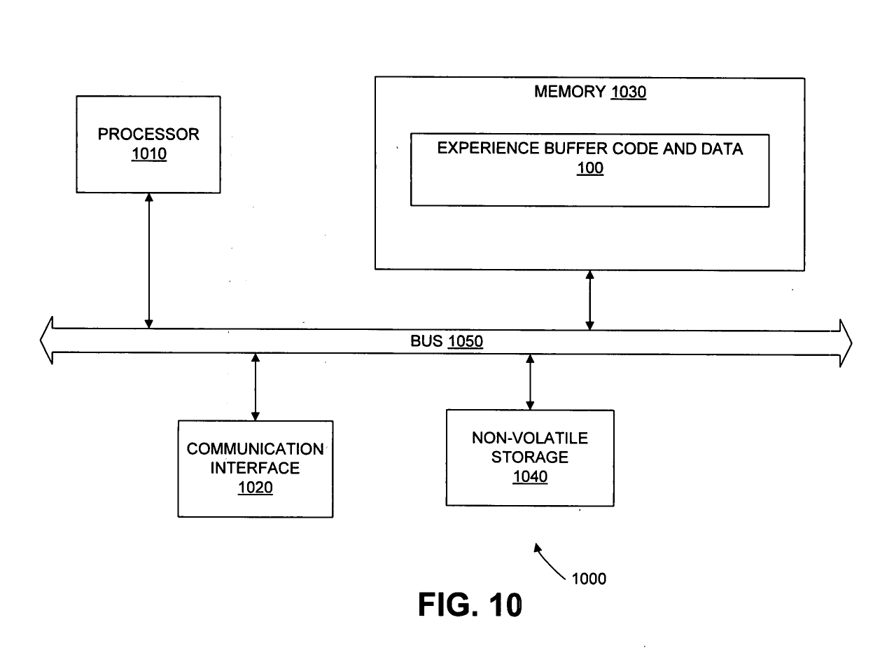

The experience buffer 100 of FIG. 1 can be abstracted as a software object, that is, a collection of data and of functions which manipulate this data, and which in combination implement the functionality described above (and further described below). An exemplary device that implements the collection of data and functions which make up the experience buffer 100 will be described later in connection with FIG. 10. In general, however, the experience buffer 100 is described herein in terms of its code and data, rather than with reference to a particular hardware device executing that code. Furthermore, although the experience buffer 100 is described in object-oriented terms, there is no requirement that the experience buffer 100 be implemented in an object-oriented language. Rather, one of ordinary skill in the art of software will understand that the experience buffer 100 can be implemented in any programming language, and executed on any hardware platform.

FIG. 2 is an object diagram of the experience buffer 100 of FIG. 1. Data members of the experience buffer 100 include the temporary buffer 120, archives 180, and archive list 1110 discussed earlier in connection with FIG. 1. Other data members include CaptureState 210 and SensorId 220 (the provider of the data stream 110). Function members include EnableCapture 230, RequestArchive 240, RetrieveArchiveContent 250, GetArchiveList 260, and DeleteArchive 270.

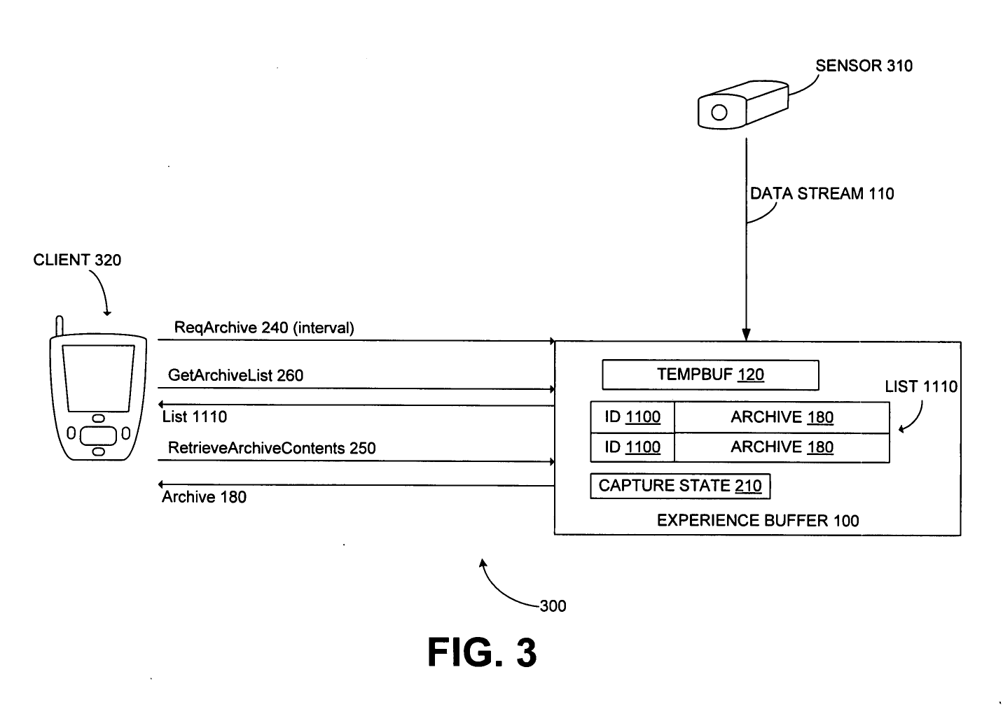

FIG. 3 is a block diagram of one embodiment of a system 300 that includes the experience buffer 100 of FIG. 1, showing the system components and interactions between them. The system 300 includes the experience buffer 100, a sensor 310, and a client 320. The client 320 may be implemented by virtually any type of computing device, such as a desktop personal computer (PC), a laptop PC, a pocket PC, or a personal digital assistant (PDA). The client 320 can also be implemented on the same computing platform as the experience buffer 100.

Sensor 310 provides a data stream 110 to the experience buffer 100. Examples of sensor 310 include: video camera; microphone; position sensor; light sensor; temperature sensor; and barometric pressure sensor. If the CaptureState 210 is enabled, the data stream 110 is continuously recorded into temporary buffer 120 as described earlier in connection with FIG. 1.

The client 320 invokes the service RequestArchive 240, specifying the archive interval 160. In response to the request, the experience buffer 100 determines which portion of the temporary buffer 120 is identified by the interval 160, then copies that portion to an archive 180. In some embodiments, RequestArchive 240 may return a handle which the client 320 can use to reference the newly created archive 180.

Using the various access services provided by the experience buffer 100, the client 320 in FIG. 3 allows a user to view or play back an archive 180. The client 320 invokes the service GetArchiveList 260 to get a list 1110 of archives in the experience buffer 100. The list 1110 includes identifying information 1100 for each archive 180. Once the contents of a particular archive 180 have been retrieved via the service RetrieveArchiveContent 250, the client 320 can play back the archived content for the user.

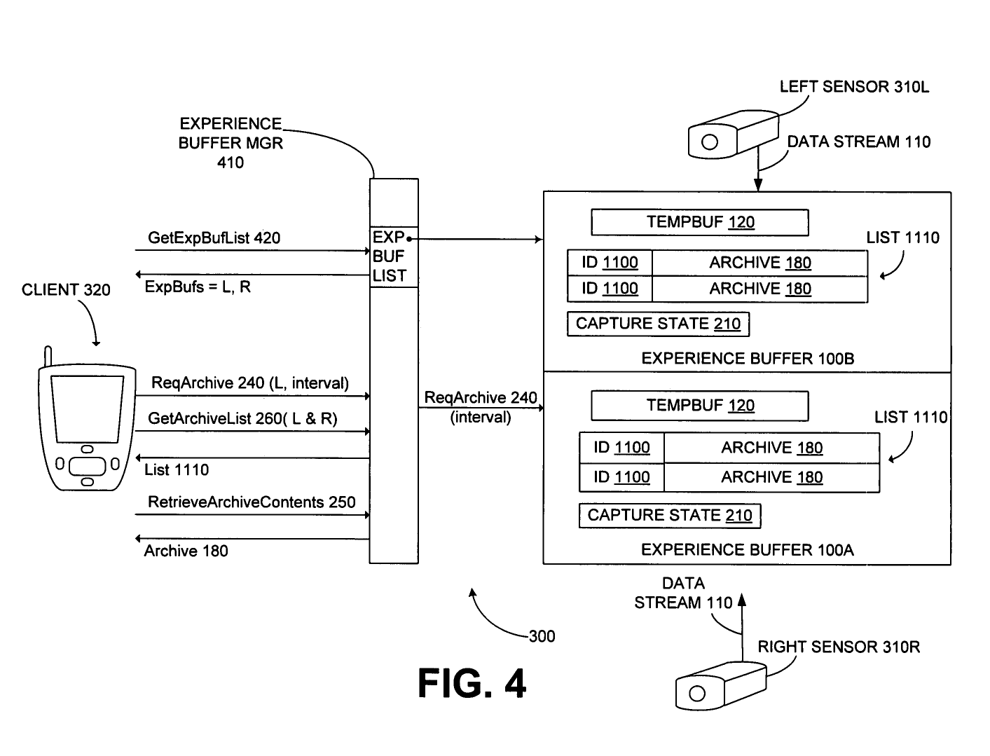

FIG. 4 shows another system 400 that includes multiple experience buffers 100. Each of these experience buffers 100 is associated with a different sensor (310L, 310R). An experience buffer manager object (410) manages experience buffers 100A and 100B. client 320 interacts with the experience buffer manager 410, and the manager 410 forwards requests to the appropriate experience buffer (100A, 100B). The functionality of the experience buffer manager object 410 and the experience buffer objects 100 can be distributed in various ways, for example: all objects implemented on the same computing platform; each object implemented on a separate computing platform; the manager implemented on one computing platform and the experience buffers on another. Other distributions of functionality are also possible, as will be understood by a person of ordinary skill in the art.

In this usage scenario, the client 320 invokes the service GetExpBufList 420, in the experience buffer manager 410, and the experience buffer manager 410 returns a list of identifiers for the experience buffers which it manages. The client 320 invokes the service RequestArchive 240, specifying the identifier of the experience buffer to be archived, as well as the archive interval 160. In this example, the client 320 specifies the “Left” experience buffer 100A, that is, the one associated with the Left sensor 310L. The experience buffer manager 410 forwards the request to the appropriate experience buffer, in this case, experience buffer 100A.

In this example, the experience buffers are identified by the associated sensor (Left, Right). These identifiers have meaning to a user interacting with the client 320. However, other identifiers can be used, including handles or references which have no intrinsic meaning to the client 320 or user. In another variation, once one or more experience buffers 100 have been identified, the client 320 uses the identifier to invoke the services of a particular experience buffer 100 directly, rather than going through the experience buffer manager 410.

The remainder of the data flow for this usage scenario is similar to the flow in FIG. 3. In response to the request, the experience buffer 100A determines which portion of the temporary buffer 120 is identified by the interval 160, then copies that portion to an archive 180. For playback, the client 320 invokes the service GetArchiveList 260 to get a list 1110 of archives. Once the contents of a particular archive 180 have been retrieved via the service RetrieveArchiveContent 250, the client 320 can play back the archived content for the user.

This embodiment differs from that described in connection with FIG. 3, in that the requested list 1110 can include archives 180 from more than one experience buffer, depending on which identifier is passed with the request. In the example scenario of FIG. 4, the request GetArchiveList 260 specifies “Left” and “Right” so the returned list 1110 includes archives 180 from experience buffers 100A and 100B. Other variations are possible, however. For example, the service GetArchiveList 260 could return archives 180 from all managed experience buffers.

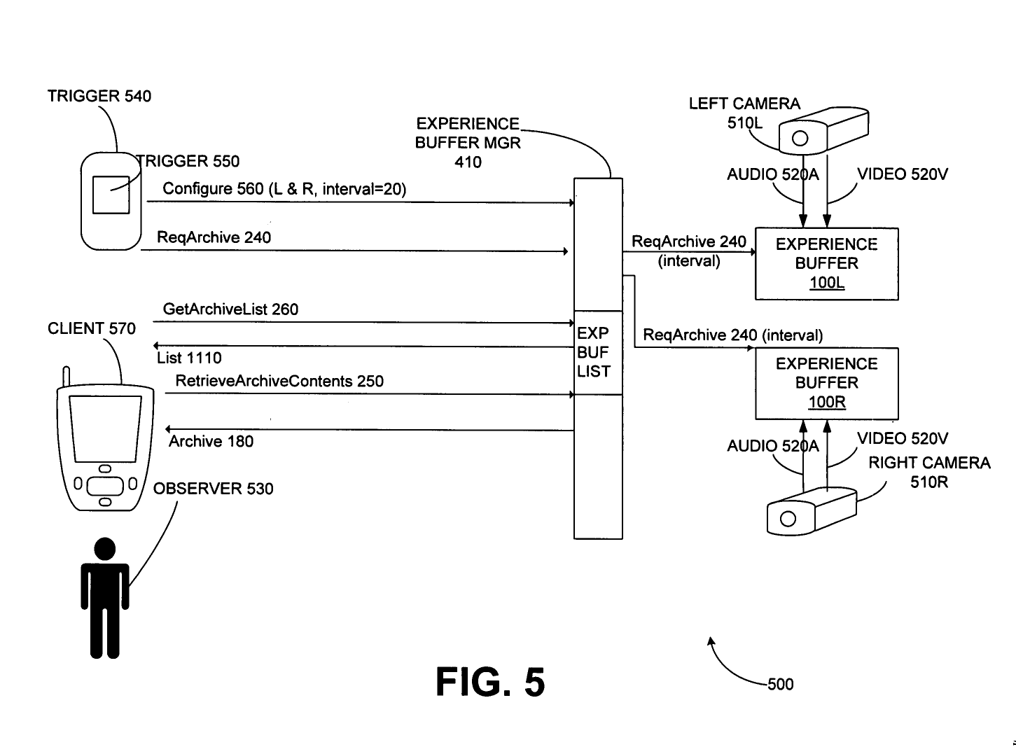

FIGS. 3 and 4 are generalized usage scenarios for experience buffer systems, with a client 320 that provides archiving and playback functionality for a user. Other embodiments that are suited for particular environments will now be described. FIG. 5 is a block diagram of one embodiment that is particularly suited for capturing and archiving instances of human behavior in a classroom setting, and especially for capturing the behavior of children with autism.

In system 500, at least one of the sensors 310 is a combination video camera and microphone 510, having a coverage area. Each camera-with-microphone (510L, 510R) transmits a video stream 520V and an audio stream 520A to one of the experience buffers (100L, 100R). The experience buffer (100L or 100R) continuously records the streams (520V and 520A) to the temporary buffer 120.

Although this example includes one device transmitting separate streams, other embodiments may include one stream per device, or a single device that produces a combined audio-video stream. In a preferred embodiment, an experience buffer 100 is associated with a single stream, but in other embodiments, an experience buffer 100 may aggregate multiple streams.

Once system 500 is started, activity within the coverage area is continuously captured by one or more experience buffers 100. When a person 530 observing the activity notices that an interesting event has taken place (e.g. the observed child made a loud noise), the observer 530 uses an experience buffer client 320 to request archiving of the activity—which has already been recorded by the experience buffer 100—into an archive 180.

In a classroom setting, it is advantageous for the mechanism used to request an archive be relatively simple, quick, and unobtrusive, so a teacher can perform the observer function without compromising the teacher's other duties. In a preferred embodiment, the experience buffer client 320 is implemented in a handheld trigger device 540 rather than a more general-purpose client device.

The trigger device 540 is a relatively small device with a trigger 550 (e.g., button, key, etc.) that, when pressed, transmits a signal to the experience buffer manager 410. Before archiving, the experience buffer manager 410 is configured (560) to associate the trigger 550 with one or more experience buffers 100. In a preferred embodiment, the default configuration associates the trigger 550 with all experience buffers in the coverage area. The experience buffer manager 410 is further configured (560) to associate the trigger 550 with an archive request interval 160 (see FIG. 2). In a preferred environment, the trigger device 540 uses a short-range wireless technology such as Bluetooth. However, other wireless technologies as well as wired technologies (e.g., Ethernet, transmission over AC power wiring, etc.) are also contemplated.

To request archiving of a recently recorded behavioral event, the observer 530 simply presses the trigger 550 shortly after noticing the behavior. In response, the trigger device 540 invokes the service RequestArchive 240 in the experience buffer manager 410. The experience buffer manager 410 determines which experience buffer(s) (100L, 100R) are associated with the trigger 550, and also determines the associated archive request interval 160. The experience buffer manager 410 forwards the request 240 to the appropriate experience buffer 100. The experience buffer 100 identifies the requested portion of the temporary buffer 120 and copies the identified portion to an archive 180. (The archiving process was described earlier in connection with FIG. 1.)

In one embodiment, the experience buffer 100 creates a link (such as a Uniform Resource Locator or URL) to the archive 180, and provides this link to the experience buffer client 320 after archiving. In a preferred embodiment, the experience buffer 100 and the experience buffer client 320 also use the short-range wireless technology (such as Bluetooth) described above. Transferring a URL over the wireless network is much faster than transferring the relatively large amount of data in the archive 180 itself. The experience buffer client 320 then connects to a higher-speed wire network at a later time, and transfers the archive 180 then.

In the embodiment of FIG. 5, the experience buffers and archive intervals are not explicitly part of the archive request 240, but are instead implicit as part of an earlier configuration of the trigger device 540. Making the interval implicit allows the archive trigger to be very simple, in this case, a single button press. The single trigger results in archival of a preconfigured time interval 160 surrounding the button press. In another variation, a single button is pressed once when a behavior is noticed, and again at a later time. The archived interval 160 in this case starts before the first button press and ends after the second button press. This interval 160 can be viewed as having two portions, a “before” portion and an “after” portion.

Yet another variation of the trigger device 540 includes multiple buttons. The observer 530 uses one button to archive instances of one behavior (e.g. child shouting) and another button to archive instances of a second behavior (e.g. child hitting). In this embodiment, the experience buffer 100 is configured to associate each button with a particular behavioral event, and the event identifier is stored with the archive 180. In another embodiment, each button corresponds to a particular child under observation, which allows multiple children to be observed in the same session.

In the classroom context, archiving of continuously recorded content offers several advantages over the conventional approaches to recording human behavioral events. The continuous recording approach is generally better than relying on a human observer to initiate recording because humans are better at noticing interesting events soon after they occur than at predicting when the event will occur. Archiving of continuously recorded content takes advantage of this human strength. In addition, archiving of continuously recorded content has advantages over non-archived continuous recording that were discussed earlier.

In the embodiment of FIG. 5, the archive request is an explicit function performed by a human observer, rather than a function that is triggered automatically when the system recognizes a behavior. This feature offers further advantages in the classroom context, where recording of human activity may be regulated or even prohibited because of concerns about the privacy of teachers and or students.

Furthermore, in the embodiment of FIG. 5, use of a short-range trigger signal means that a human observer requesting the archive is in relative physical proximity to the archiving system 500. This gives the people under observation some information about when archiving can take place. In the classroom context, this feature can be considered an advantage over a system that allows a remote user (e.g., a school administrator) to request an archive, since in that case the actors would not be aware of archiving activity.

In the embodiment of FIG. 5, trigger device 540 is a specialized client of the experience buffer manager 410 which uses the archiving services. A user can view or play back all of archives 180 using another more general-purpose client 570. The client 570 may be implemented by virtually any type of computing device, such as a desktop personal computer (PC), a laptop PC, a pocket PC, or a personal digital assistant (PDA). The process of viewing/playback with client 570 is similar to the process described earlier in connection with FIGS. 3 and 4.

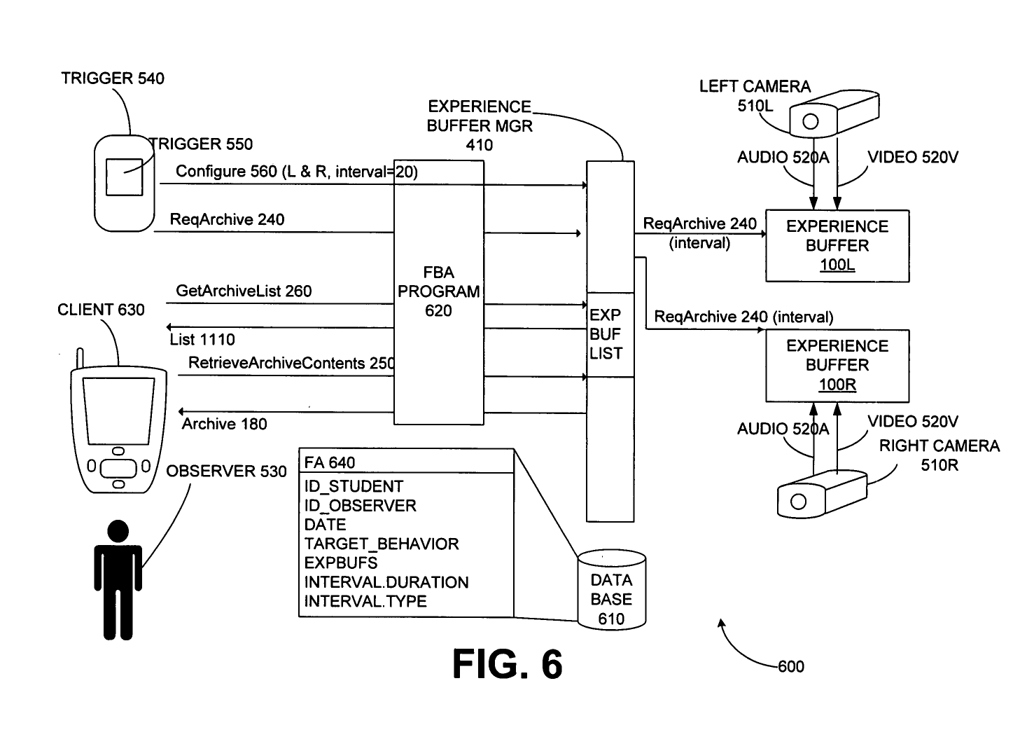

Another embodiment particularly suited for capturing the behavior of children with autism is shown in the system diagram of FIG. 6. This system 600 includes sensors (510L, 510R), a trigger device 540, an experience buffer manager 410, and experience buffers (100L, 100R). The system 600 also includes a database 610 which stores data related to the behavioral events archived by the experience buffers 100 and a functional behavior analysis (FBA) component 620 which accesses the database 610. A client 630 uses the services of the FBA component 620 to input, edit, analyze, and view this Functional Analysis data.

In one embodiment, the FBA component 620 is implemented as a standalone application, and executes on the same computing platform as the experience buffer manager object 410 and the experience buffer objects 100. However, a person of ordinary skill in the art will understand that the functionality described here can be distributed among different computing platforms in various ways. As just one example, in another embodiment the FBA component 620 and the client 630 are implemented on the same computing platform.

In FIG. 6, the trigger device 540 and the client 630 interact with the FBA component 620, which interfaces with the experience buffer manager 410 and the database 610. Alternatively, the trigger device 540 and the client 630 could bypass the FBA component 620 and interface to the experience buffer manager 410 directly.

The actions of trigger device 540 are similar to those described in connection with FIG. 5. The trigger device 540 invokes a configuration function (560) to associate the trigger 550 with one or more experience buffers 100, and to set an archive request interval 160. The trigger device 540 invokes the service RequestArchive 240 to request an archive. The actions of client 630 used to retrieve an archive are also similar to those described in connection with FIG. 5 (e.g. GetArchiveList 260, RetrieveArchiveContent 250).

In addition to these basic archiving and playback capabilities, the client 630 in FIG. 6 can input, edit, analyze, and view data related to archived behavioral events. More specifically, each archive 180 is associated with a particular Functional Analysis (FA) for a specific student. Thus, before archiving one or more FA objects (640) are created and stored in the database 610. The FA object 640 contains data specific to a particular Functional Analysis, for example: student identifier; observer identifier; start date of observation; name and operational definition of target behavior; and expected frequency of target behavior.

The FA object 640 also identifies the experience buffers 100 that will be used to record and archive instances of the target behavior. In a preferred embodiment, the FA object 640 is associated with one or more rooms (sensor coverage areas), and all experience buffers 100 within those rooms are available for recording and archiving. In another embodiment, the FA object 640 is directly associated with individual experience buffers 100.

The FA object 640 also contains the archive interval and the interval type (e.g. one-click or two-click before/after as described in connection with FIG. 5). In a preferred embodiment, the FA object 640 contains a single archive interval and type which is used for all experience buffers 100 associated with the associated FA object 640. In another embodiment, the FA object 640 contains one interval and type for each of its associated experience buffers 100.

The association between FA object and experience buffer is two-way. An FA object 640 is associated with one or more experience buffers 100 as described above. In addition, the object representing each of these experience buffers 100 is associated with the FA object 640. In this manner, a reference to an FA object 640 can be used to determine the associated experience buffer objects 100, and a reference to an experience buffer object 100 can be used to determine the associated FA object 640. These associations can be explicit in the object (e.g., the two objects contain references to each other), or can be implicit (e.g., the FA object 640 contains the experience buffer objects 100).

After an FA object 640 is created, an observer 530 watches for instances of the target behavior defined in the FA object 640, and creates archives 180 of this behavior using the trigger device 540. In one embodiment, observer 530 is a human, but in other embodiments the observer 530 is implemented in software that, for example, detects target behavior using sensors, or that archives at predefined times.

In the preferred embodiment, a single trigger results in multiple archives 180, since the trigger is associated with all experience buffers 100 within the room. Whenever an archive is created, the preferred embodiment of the client 630 indicates this creation by displaying a list of archived behaviors for the day, identified by timestamp.

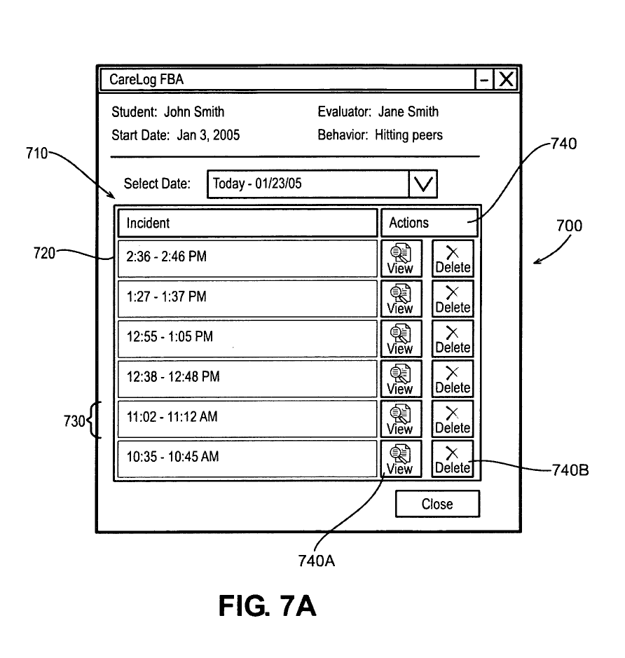

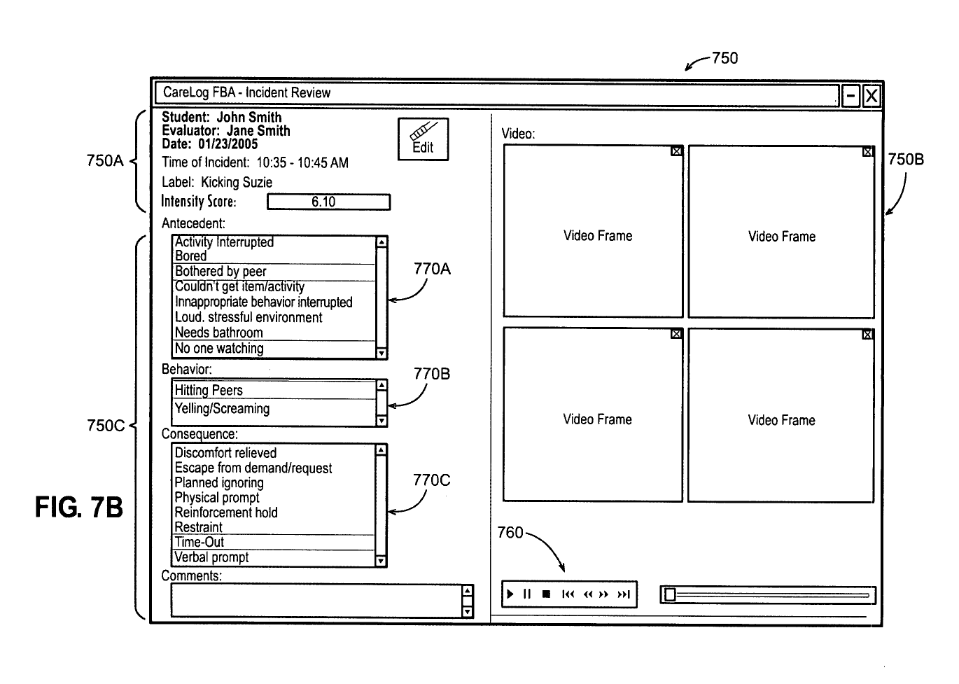

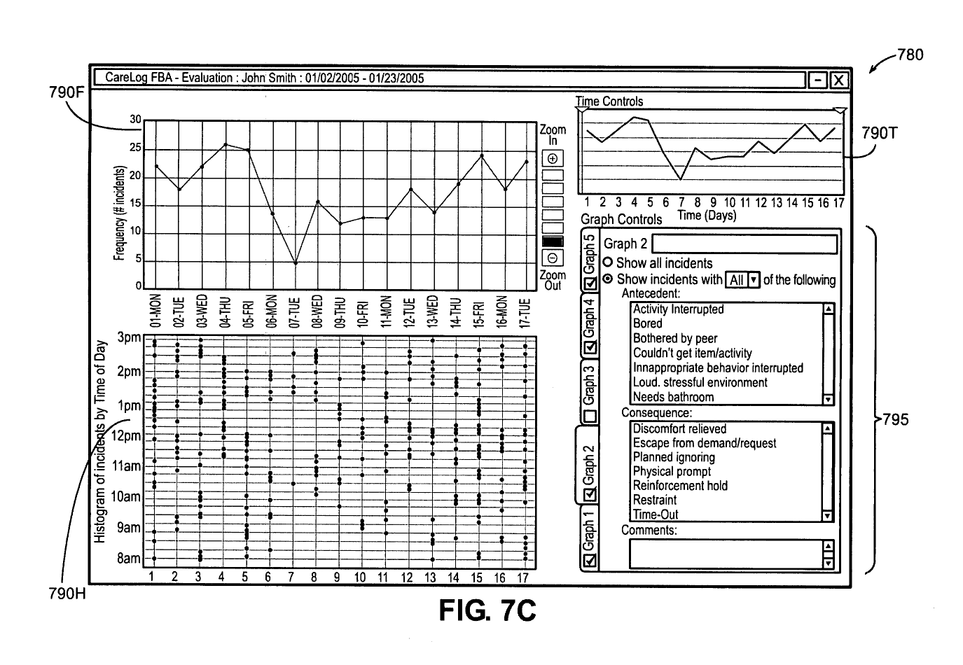

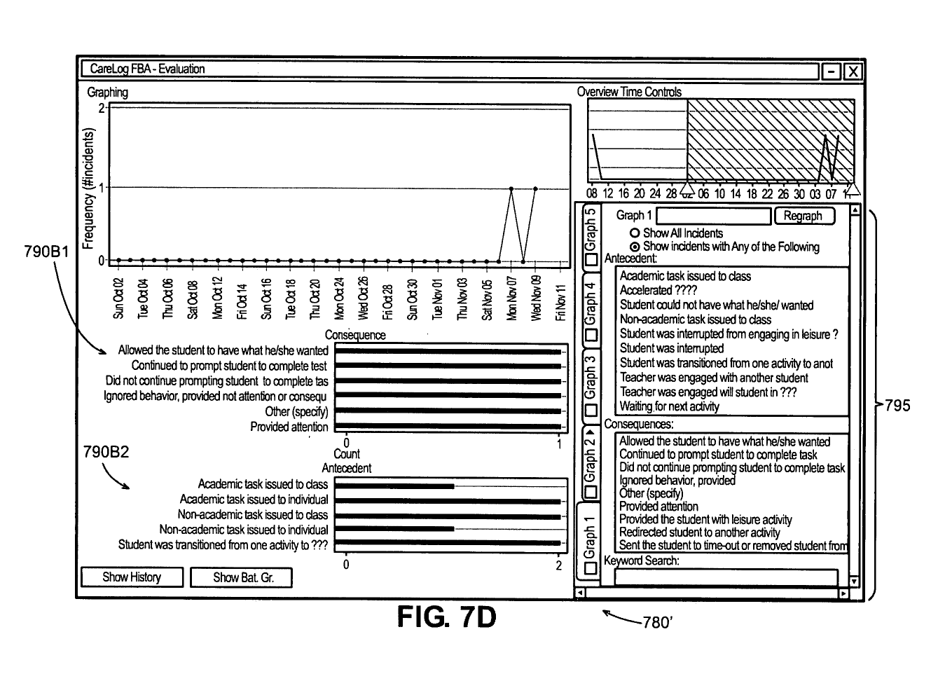

FIG. 7A-C show an example of a user interface implemented on the client 630 which allows viewing and editing of an FA object 640. The client 630 first queries the experience buffer manager 410 (either directly, or through the FBA component 620) for a list 1110 of archives 180 and identifying information 1100 about each one. In the preferred embodiment, a single archive request results in multiple experience buffers 100

The client 630 uses the information returned to display a window 700. Through this window 700, the user is presented with a behavioral event list control 710 containing identifying information such as time/date 720. In the preferred embodiment, each behavioral event 730 in the list 710 may correspond to multiple archives, each one a recording of the same time interval by a different experience buffer/sensor. In this embodiment, the user thinks in terms of behavioral events rather than archives.

The user selects a behavioral event 730 from the list 710 and chooses an action 740 for the selected behavioral event 730. In this example, the actions 740 include View/Edit (740A) and Delete (740B).

If the user selects Delete (740B), the client 630 invokes the Delete service for the selected behavioral event 730. If the event 730 corresponds to multiple archives 180, then the Delete service is invoked for each one.

If the user selects View/Edit (740A), the client 630 queries the FBA component 620 to get the FA object 640 that is associated with the selected behavioral event 730. The client 630 then presents a window 750 (FIG. 7B), showing either some or all of the data in the FA object 640, including the archive content. In a preferred embodiment, the window 750 is divided into three portions. Information identifying the FA is displayed in one portion (750A). A single still frame from each of the archives 180 is displayed in a second portion 750B. A user can interact with a set of playback controls 760 to simultaneously play back the archive content in the second window portion 750B.

Tag information 770 is displayed in a third portion (750C) of the window. Tag information 770 is an annotation that categorizes the behavioral event 730. In a preferred embodiment, the tag information 770 includes one target behavior 770T, one or more antecedent behaviors 770A (occurring before the target behavior) and one or more consequence behaviors 770C (occurring after the target behavior).

The tag information 770 may be associated with a particular portion of the archive 180, or with the archive 180 as a whole. If associated with a portion, then the tag information 770 includes offset values that identify the relevant portion of the archive 180.

In other embodiments, tag information 770 includes additional meta-data related to the behavioral event 730. One example of additional meta-data is a notation of a “setting event,” which is an antecedent behavior that occurs well in advance of the behavioral event 730. Another example of additional meta-data is freeform text notes recorded by an observer.

Tag information 770 is editable, preferably from the same window 750 used for viewing. In a preferred embodiment, each type of tag information 770 is displayed in a list box control, and a user edits the tag information 770 by selecting one or more items from the list box. The behavioral items which populate the list box control are associated with the FA object 640. These behavioral items can be defined when the FA object 640 is created or at a later time. The FA object 640 in the database 610 is updated after editing.

FIG. 7C is a screen 780 showing various graphical views that can be generated for a particular Functional Analysis object 640. In a preferred embodiment, the user can generate one or more of the following types of graphs: a time plot 790T, a frequency graph 790F, a histogram 790H. The time plot 790T shows an overview of all target behavior events, plotted against the time of occurrence. The frequency graph 790F plots the number of target behavior events that occurred each day. The histogram 790H plots the time distribution of target behavior events within each day. The frequency graph 790F and histogram 790H can depict either the entire timeline shown in the time plot 790T, or a particular portion of the timeline.

FIG. 7D is a screen 780′ showing another type of graphical view for a Functional Analysis object 640. The bar graph 790B1 presents the totals for the occurrence of various types of consequence behavioral events, while bar graph 790B2 presents the totals for various types of antecedent behavioral events.

To generate a particular graph, user interacts with the graph control 795 on screen 780 or 780′. A user may include or exclude any combination of tags (e.g. antecedent behaviors 770A, consequent behaviors 770C, etc.). A user can search for target behaviors that contain particular keywords in the text notes meta-data. A user can select a particular plotted point on any of the graphs and double-click to display the View/Edit window 750 for a particular target behavior event.

A person of ordinary skill in the art will understand that the graphs and views show in FIGS. 7A-D are merely representative of some types of queries that a user may do, but the system described herein is not limited to such. The system as contemplated encompasses other representations of meta-data also.

The embodiments in FIGS. 5-7 are particularly suited for capturing and archiving the behavior of children with autism in a classroom setting. In another variation, these embodiments are situated in a child's home rather than classroom. Situating the system in a home allows parents to control which behaviors are archived, and which archives are communicated with doctors, educators, therapists and other professionals. In this embodiment, it is contemplated that parents will archive behavioral incidents, and professionals will create one or more functional analyses after viewing and tagging or annotating the archived behaviors.

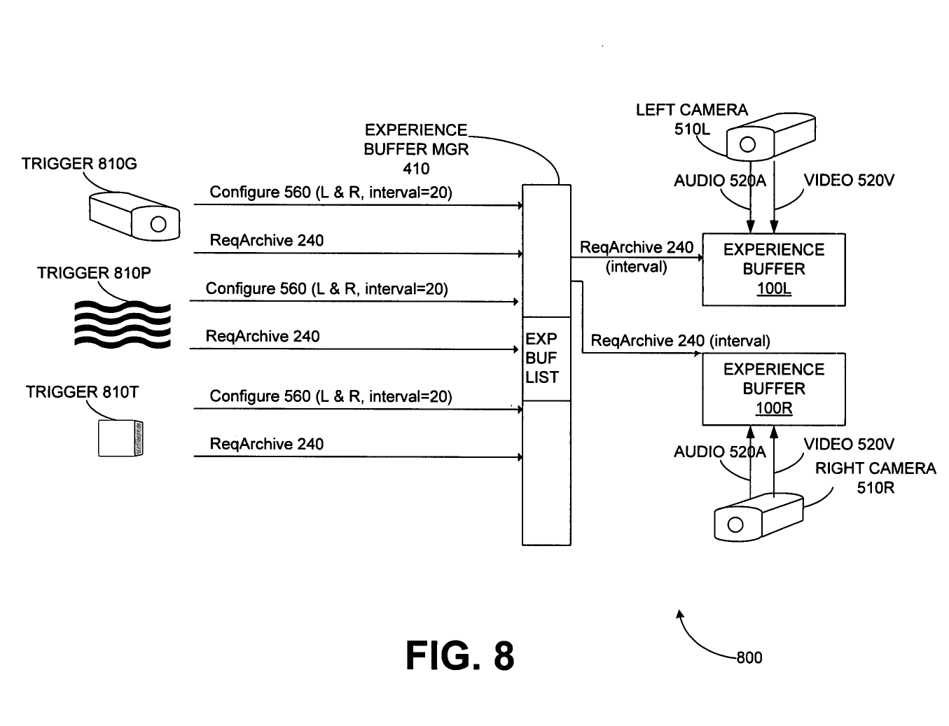

FIG. 8 is a system diagram of another embodiment particularly suited for tracking child development in a home. Incidents of child development milestones can be recorded, archived, and shared with doctors, educators, therapists and other professionals. Examples of child development milestones include turning over, gazing, pointing, verbalizing, sitting up, standing, etc. Explicit triggers 540, such as the ones discussed earlier, allow for a parent or other observer 530 to explicitly archive behaviors. In this context, automatic triggers 810 are also particularly useful for recognizing behaviors and triggering an archive on recognition, so that behaviors that occur when no observer 530 is present can also be archived.

FIG. 8 shows several different types of automatic triggers 810. Trigger 810G is a gesture recognition device that recognizes gestures made by the observed child, such as pointing. In one embodiment, gesture recognition device 810G includes a camera and image processing software. Trigger 810P is a motion/positional sensor which recognizes various body motions of the observed child, such as turning over, sitting up, standing, etc. Trigger 810T is an instrumented toy or other object that recognizes specific interactions with the observed child, e.g. the child picking up the toy, or moving the toy from one hand to another. In one embodiment, the instrumented toy 810T contains some combination of gyroscope, positional sensor, motion sensor, and/or accelerometer.

Another embodiment (not shown) of a triggered, archivable experience buffer is particularly suited for senior citizens, or adults with disabilities, who live alone. In this embodiment, the experience buffer is located in a home, and captures information including video, the resident's vital signs (e.g., pulse, blood pressure, breathing rate, etc.), and information about the home environment (e.g., temperature, level of carbon monoxide, etc.). The resident of the home can trigger the archive after a particular event such as a fall, or chest pain, or difficulty in breathing. The archive is then automatically transmitted to a caregiver or healthcare personnel, who can evaluate the event and decide if intervention is appropriate.

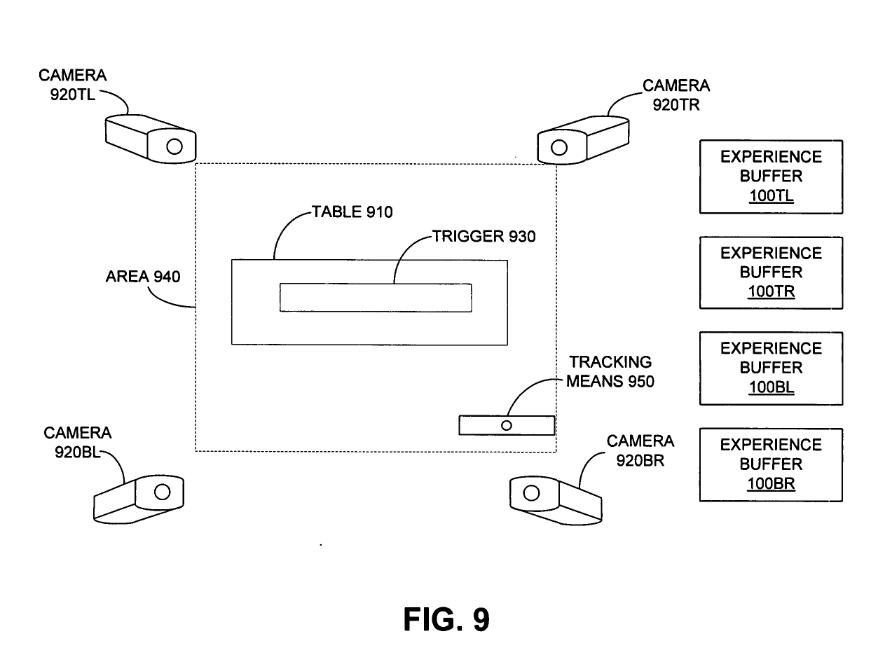

FIG. 9 is a system diagram of another embodiment of a triggered, archivable experience buffer. The embodiment of FIG. 9 is particularly suited for archiving informal social interactions, such as meetings or conversations, in a semi-public space. Informal social interactions typically include an implicit contract that behaviors will not be recorded. Therefore, it is desirable in this context that the archival is explicitly triggered by a human, preferably in a manner that is easily observed by others in the space. System 900 includes a table 910 (or other flat surface), cameras 920, trigger device 930, and experience buffers 100. Cameras 920 continuously record activity in the area 940 surrounding table 910, where the table 910 provides a focal point for the social activity. Importantly, trigger device 930 is located within the observed area 940. In one embodiment, the trigger device 930 is a touchscreen located on or within the table 910. In this manner, a person activating the touchscreen trigger 930 is present within the area 940 at the time of the archive request, and the archive request is observable to others within the area 940. In another embodiment, the trigger device 930 is a button, or is integrated into a mobile device such as a phone or personal digital assistant (PDA).

In this informal semi-public context, it is preferable that the person requesting the archive provide additional information at the time of the request, rather than using preconfigured parameters. For example, the archive requester can specify the archive interval 160 and an archive location (e.g., a filename, a server name, a Uniform Resource Locator (URL), etc.).

In some social contexts, it is desirable for the persons being observed to explicitly give permission for an archive 180 to be stored. Therefore, in one embodiment, the experience buffer 100 obtains additional input at the time of an archive request 240, where this input indicates permission of the persons present within the observed area 940 at the time of the archive request 240. This embodiment may optionally include a tracking means 950 which tracks the entry of persons into the observed area 940, and the exit of persons out the area 940. The tracking means 950 provides the experience buffer 100 with a list of persons within the observed area 940, and the experience buffer 100 obtains input indicating that these persons give permission for the archive. In one embodiment, the tracking means 950 is a computer program that allows persons to sign in and out of the system 900. In another embodiment, the tracking means 950 is a computing platform that contains identification functionality (e.g. electronic badge scanner, fingerprint scanner, voice recognition).

FIG. 10 is a hardware block diagram of an example device that implements the experience buffer 100 of FIG. 1. The device 1000 contains a number of components that are well known in the art of ubiquitous computing, including a processor 1010, a communication interface 1020, memory 1030, and non-volatile storage 1040. Examples of non-volatile storage include, for example, a hard disk, flash RAM, flash ROM, EEPROM, etc. These components are coupled via bus 1050. Memory 1030 contains data and code which, when executed on processor 1010, implement at least one experience buffer 100 in accordance with the system and method for archiving of continuous capture buffers described herein. In a preferred embodiment, communication interface 1020 is a local area network (LAN) such as Ethernet (802.1x) or WiFi (802.11x). However, other multiple access media can be used (e.g., wide area network), as well as point-to-point links (e.g., modem).

Omitted from FIG. 10 are a number of conventional components, known to those skilled in the art, that are not necessary to explain the operation of the system and method for archiving of continuous capture buffers.

The foregoing description has been presented for purposes of illustration and description. It is not intended to be exhaustive or to limit the invention to the precise forms disclosed. Obvious modifications or variations are possible in light of the above teachings. The embodiments discussed, however, were chosen and described to illustrate the principles of the invention and its practical application to thereby enable one of ordinary skill in the art to utilize the invention in various embodiments and with various modifications as are suited to the particular use contemplated. All such modifications and variation are within the scope of the invention as determined by the appended claims when interpreted in accordance with the breadth to which they are fairly and legally entitled.

What I claim is:

1. A method of archiving a stream of sensor data, the method comprising the steps of:
receiving a stream of sensor data from at least one corresponding sensor device, the sensor device having a coverage area;
storing the sensor data to a corresponding capture buffer;
receiving, from a trigger device that is proximate to the sensor coverage area, a request to archive a portion of the capture buffer, wherein a user explicitly originates the archive request; and
responsive to the archive request, copying the requested portion of the capture buffer to an archive buffer.

2. The method of claim 1, wherein the storing step further comprises:
storing the sensor data to the capture buffer in a circular manner such that newly recorded data persists for a buffer duration and is discarded after the buffer duration.

3. The method of claim 1, further comprising the steps of:
providing, to a client, an identifier of the archive buffer.

4. The method of claim 1, further comprising the steps of:
receiving, from a client, an archive buffer identifier; and
transmitting, to the client, the contents of the identified archive buffer.

5. The method of claim 1, further comprising the steps of:
determining an event interval associated with the archive request; and
identifying the requested portion based on the event interval.

6. The method of claim 1, further comprising the steps of:
configuring the trigger device so that a predetermined event interval is associated with the trigger device; and
responsive to the archive request received from the trigger device at a request time, identifying the requested portion based on the request time and the predetermined event interval.

7. The method of claim 1, wherein the at least one sensor device comprises a plurality of sensor devices, the method further comprising the steps of:
determining which of the at least one of the plurality of sensor devices is associated with the trigger device; and
responsive to the archive request received from the trigger device, identifying the requested portion based on the associated sensor device.

8. The method of claim 1, wherein the at least one sensor device comprises a plurality of sensor devices, the method further comprising the steps of:
configuring the trigger device so that the plurality of sensor devices is associated with the trigger device;
configuring the trigger device so that a predetermined event interval is associated with the trigger device;
responsive to the archive request received at a request time:
identifying the requested portion based on the request time and the predetermined event interval; and
copying the requested portion of each corresponding capture buffer to a corresponding archive buffer.

9. A system for archiving a stream of sensor data, comprising:
means for receiving a stream of sensor data from at least one corresponding sensor device, the sensor device having a coverage area;
means for capturing the sensor data to a corresponding buffer;
means for receiving, from a trigger device that is proximate to the sensor coverage area, a request to archive a portion of the capture buffer, wherein a user explicitly originates the archive request; and
means for copying the requested portion of the capture buffer to an archive buffer, in response to the archive request.

10. The system of claim 9, wherein the means for capturing further comprises:
means for storing the sensor data to the capture buffer in a circular manner such that newly recorded data persists for a buffer duration and is discarded after the buffer duration.

11. The system of claim 9, further comprising:
means for providing, to a client, an identifier of the archive buffer.

12. The system of claim 9, further comprising the steps of:
means for receiving, from a client, an archive buffer identifier; and
means for transmitting, to the client, the contents of the identified archive buffer.

13. The system of claim 9, further comprising:
means for determining an event interval associated with the archive request; and
means for identifying the requested portion based on the event interval.

14. The system of claim 9, further comprising:
means for configuring the trigger device so that a predetermined event interval is associated with the trigger device; and
means for identifying the requested portion, based on a request time at which the archive request received from the trigger device, and based on the predetermined event interval.

15. The system of claim 9, wherein the at least one sensor device comprises a plurality of sensor devices, the system further comprising:
means for determining which at least one of the plurality of sensor devices is associated with the trigger device; and
means for identifying the requested portion based on the associated sensor device.

16. The system of claim 9, wherein the at least one sensor device comprises a plurality of sensor devices, the system further comprising:
means for configuring the trigger device so that the plurality of sensor devices is associated with the trigger device;
means for configuring the trigger device so that a predetermined event interval is associated with the trigger device;
means for identifying, responsive to the archive request received at a request time, the requested portion based on the request time and the predetermined event interval; and
means for copying, responsive to the archive request received at a request time, the requested portion of each corresponding capture buffer to a corresponding archive buffer.

17. A method of archiving a stream of sensor data, the method comprising the steps of:
receiving a stream of sensor data from at least one corresponding sensor device, the sensor device having a coverage area;
storing the sensor data to a corresponding capture buffer;
receiving, from a trigger device that is proximate to the sensor coverage area, a request to archive a portion of the capture buffer, wherein the trigger device originates the request in response to an automatically recognized behavior occurring within the coverage area; and
responsive to the archive request, copying the requested portion of the capture buffer to an archive buffer.

18. The method of claim 17, wherein the trigger device comprises a gesture recognition device, and wherein the gesture recognition device originates the request in response to recognizing a gesture within the coverage area.

19. The method of claim 17, wherein the trigger device comprises a positional sensor, and wherein the trigger device originates the request in response to recognizing a specific body motion of a person within the coverage area.

20. The method of claim 17, wherein the storing step further comprises:
storing the sensor data to the capture buffer in a circular manner such that newly recorded data persists for a buffer duration and is discarded after the buffer duration.

21. The method of claim 17, further comprising the steps of:
providing, to a client, an identifier of the archive buffer.

22. The method of claim 17, further comprising the steps of:
receiving, from a client, an archive buffer identifier; and
transmitting, to the client, the contents of the identified archive buffer.

23. The method of claim 17, further comprising the steps of:
determining an event interval associated with the archive request; and
identifying the requested portion based on the event interval.

24. A system of archiving a stream of sensor data, the system comprising:
means for receiving a stream of sensor data from at least one corresponding sensor device, the sensor device having a coverage area;
means for storing the sensor data to a corresponding capture buffer;
means for receiving, from a trigger device that is proximate to the sensor coverage area, a request to archive a portion of the capture buffer, wherein the trigger device originates the request in response to an automatically recognized behavior occurring within the coverage area; and
means for copying, responsive to the archive request, the requested portion of the capture buffer to an archive buffer.

25. The system of claim 17, wherein the trigger device comprises a gesture recognition device, and wherein the gesture recognition device originates the request in response to recognizing a gesture within the coverage area.

26. The system of claim 17, wherein the trigger device comprises a positional sensor, and wherein the trigger device originates the request in response to recognizing a specific body motion of a person within the coverage area.

27. The system of claim 17, wherein means for storing further comprises:
means for storing the sensor data to the capture buffer in a circular manner such that newly recorded data persists for a buffer duration and is discarded after the buffer duration.

28. The system of claim 17, further comprising:
means for providing, to a client, an identifier of the archive buffer.

29. The system of claim 17, further comprising:
means for receiving, from a client, an archive buffer identifier; and
means for transmitting, to the client, the contents of the identified archive buffer.

30. The system of claim 17, further comprising:
means for determining an event interval associated with the archive request; and
means for identifying the requested portion based on the event interval.
